(19) United States
(12) Patent Application Publication
(10) Pub. No.: US 2020/0212623 A1
(43) Pub. Date: Jul. 2, 2020

(54) Trailer Wire Harness Storage, Securing and Protection Device

(71) Applicants: Alan McNaul, Victoria (CA); Victor Jose Cunha, Nanaimo (CA)

(72) Inventors: Alan McNaul, Victoria (CA); Victor Jose Cunha, Nanaimo (CA)

(21) Appl. No.: 16/232,845

(22) Filed: Dec. 26, 2018

(51) Int. Cl. H01R 13/60; H01R 13/443; B60D 1/64

(52) U.S. Cl. CPC H01R 13/60; H01R 13/443; B62D 63/08; H01R 2201/26; B60D 1/64

(57) ABSTRACT

A series of one-piece, polyvinylchloride, injection moulded devices for storing, protecting, and securing various common types of terminal end connectors of a trailer light or combined trailer light and braking system wiring harness including an electrically non-conductive—plug receiving—base having a female receptacle therein, or combination of female receptacle therein and a laterally adjacent, elongated male dummy plug for receiving complementary formed, electrically conductive, male and female electrical terminals, respectively, provided in the terminal end connector. A mechanism is provided for mounting the electrically non-conductive—plug receiving—base on a trailer structure or vehicle adjacent to the terminal end connector in order to secure and protect the various terminal end connectors of a trailer light or combined trailer light and braking system wiring harness.

### CROSS REFERENCE TO RELATED APPLICATIONS

Nil

### STATEMENT OF FEDERALLY SPONSORED RESEARCH OR DEVELOPMENT

Nil

### THE NAMES OF THE PARTIES TO A JOINT RESEARCH AGREEMENT

Nil

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

Nil

### BACKGROUND OF THE INVENTION

It is conventional to provide electrical power to the lights of a trailer via wiring harnesses on the draft vehicle and the trailer which have mating terminal end connectors that are detachably coupled together. These connectors each have one or more electrically conductive male pin terminals and one or more electrically conductive socket terminals which receive the complimentary formed, female and male electrically conductive terminals on the other connector. When the draft vehicle is not coupled to the trailer, and the wiring harnesses are not coupled together, the harnesses are typically left hanging from either the draft vehicle or the trailer and exposed to the elements. Sometimes dirt, snow, ice, or moisture fill the electrically conductive socket members and thus, cannot be used until cleaned. If the terminals are exposed to moist environments corrosion of the connectors can lead to complete failure of the terminal conductive surfaces. This is particularly frustrating to the trailer user. Additionally, the uncoupled connector ends on the draft vehicle or trailer will sometimes drag on the ground and become damaged. Accordingly it is an object of the present invention to provide a new and novel device for securing the trailer wire harness and providing protection; preventing dirt, ice, moisture or other foreign matter from contaminating the trailer light harness coupling members when not in use.

### DESCRIPTION OF RELATED ART

When disconnecting a trailer from a towing vehicle, it would be helpful to provide a device mounted on the trailer in which the male plug of the trailer may be stored when the trailer is not in use. The device should provide a relatively snug fit, with no moving parts, while protecting the electrical plug from exposure to the weather, etc. The device should be constructed of a semi-flexible polyvinylchloride material that is damage resistant in all typical North American temperature extremes.

U.S. Pat. No. 6,705,880, issued Mar. 16, 2004 describes a sleeve type trailer plug holder having an end cap for sealing the open end. The plug holder '880 patent is designed with spring biased moving parts and is of rigid design.

U.S. Pat. No. 6,638,083, issued Oct. 28, 2003 describes a sleeve type trailer plug holder having an end cap for sealing the open end. The plug holder '083 patent is designed with spring biased moving parts and is of rigid design.

U.S. Pat. No. 3,176,257, issued Mar. 30, 1965 describes a bracket for holding trailer plugs of tractor-trailer vehicles. The plug holder '257 patent is designed to rotatably receive a specific type of plug, and the plug holder has no covering to keep out dust, etc, and is of rigid design.

U.S. Pat. No. 3,482,203, issued Dec. 2, 1969, to Whitright describes an electrical connector storing device for trailers. This device has no cover for protection to keep out dust, etc. when not in use, is of rigid design, and relies on a ring or bail to hold the male connector. The ring device requires a particular type of plug shape where it is attached to the wire conduit in order to maintain the plug in the hood or protector.

U.S. Pat. No. 4,017,136, issued Apr. 12, 1977 to Sasgen, describes a male plug holder for holding a plug for a locomotive control cable when not in use. The male plug holder is oriented in a forward position, thus allowing rain or other environmental hazards into the plug. The plug holder of the '136 patent is designed for a particular plug for a train locomotive and would not be practical for vehicle-pulled trailer connectors.

U.S. Pat. No. 4,738,641, issued Apr. 19, 1988, to Eversol, Jr., describes a spring loaded trailer electrical connector protector device for protecting male trailer connectors when not in use and is of rigid design. The '641 device requires wings which fit into notches at the lower end of the device which is an uncommon feature on many trailer connectors.

U.S. Pat. No. 4,770,644, issued Sep. 13, 1988, to Feder, describes a typical trailer plug connector of the type contemplated by the present invention and a receiving towing vehicle female connector having a hinged spring cover.

U.S. Pat. No. 5,380,209, issued Jan. 10, 1995, to Donvers, Jr. et al. describes a trailer connector housing which has an upward opening lid and side slots to receive electrical wires, and, a screw-on protector and casing for attachment to the vehicle. The trailer connector housing of the '209 patent has many moving parts, is subject to entrance of environmental rain or dust, and is of rigid design.

U.S. Pat. No. 5,630,728, issued May 20, 1997, to Watters, Jr., describes a plug holder for trailers or towing vehicles. The '728 holder is vertically or horizontally mounted, allowing entrance of rain or mud, is open to the environment allowing corrosion of end terminal connectors, and is of rigid design.

U.S. Pat. No. 5,722,854, issued Mar. 3, 1998, to Geisler, describes a sleeve type trailer plug holder having an end cap for sealing the open end. The '854 device requires a snug fit between the plug holder and the trailer plug. The end cap must be inserted to assure protection from the elements. The end cap is subject to accidental removal, allowing the elements to enter the plug holder. The user may also forget to fasten the end cap securely.

U.S. Pat. No. 5,800,188, issued Sep. 1, 1998, to Barber et al., describes a trailer tow inter-connector having a spring-loaded cover and integral electrical components and some moving parts.

None of the above inventions and patents, taken either singly or in combination, is seen to describe the instant invention as claimed.

### SUMMARY

A series of devices for storing, protecting, and securing various common types of terminal end connectors of a trailer light or combined trailer light and braking system wiring harness including an electrically non-conductive—plug receiving—base having a female receptacle therein, or combination of female receptacle therein and a laterally adjacent, elongated male dummy plug for receiving complementary formed, electrically conductive, male and female electrical terminals. respectively, provided in the terminal end connector. A mechanism is provided for mounting the electrically non-conductive—plug receiving—base on a trailer structure or vehicle adjacent to the terminal end connector in order to secure and protect the various terminal end connectors of a trailer light or combined trailer light and braking system wiring harness when it is not in use.

### DESCRIPTION OF THE DRAWINGS

The invention may be more readily understood by referring to the accompanying drawings of each application of the device, in which:

FIG. 1—Pictorial Side Elevation Views

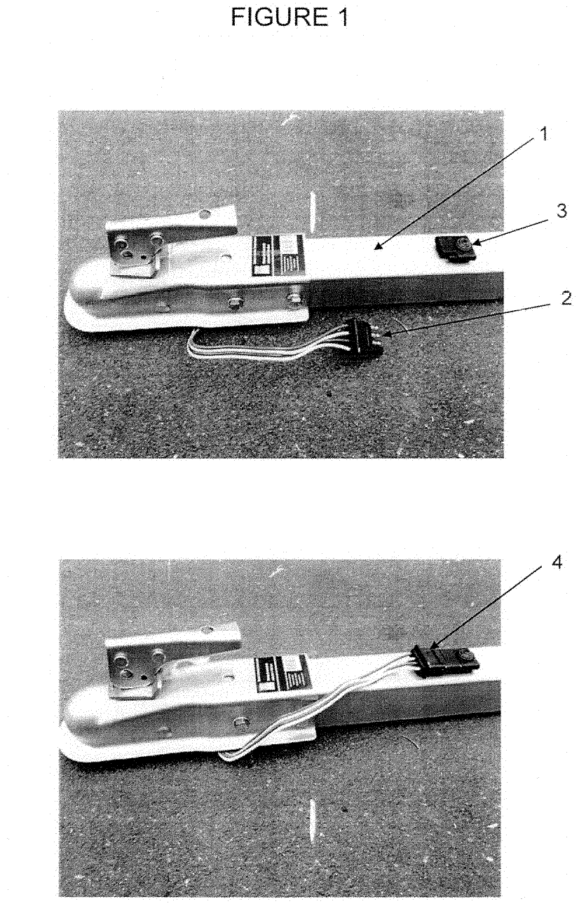

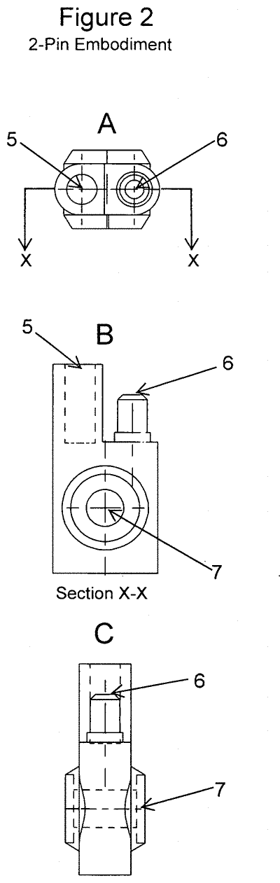

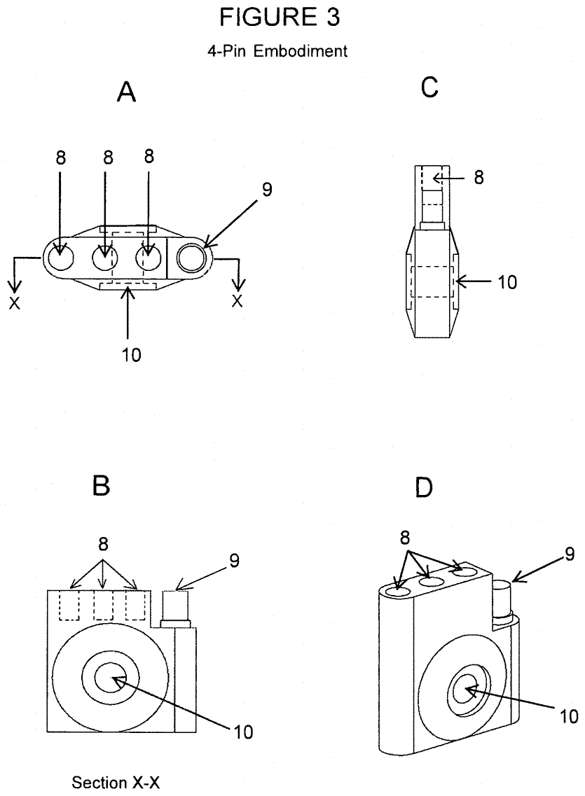

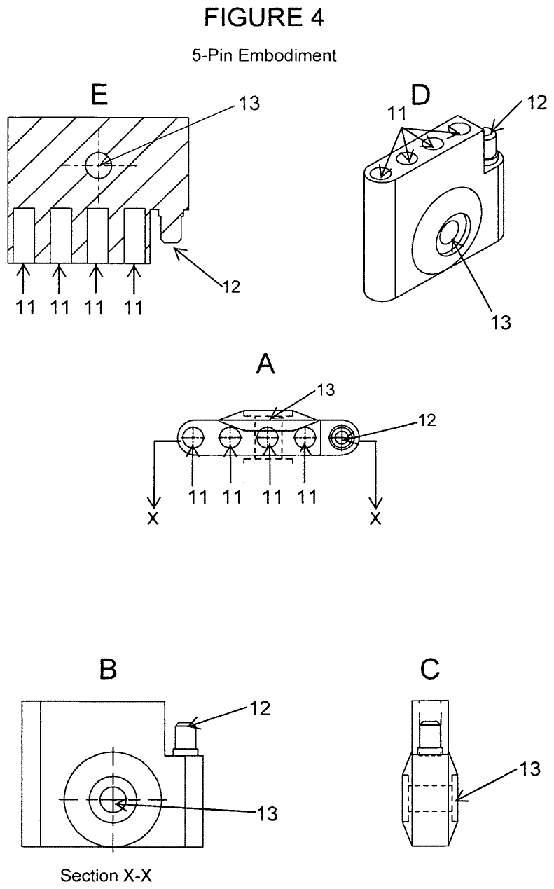

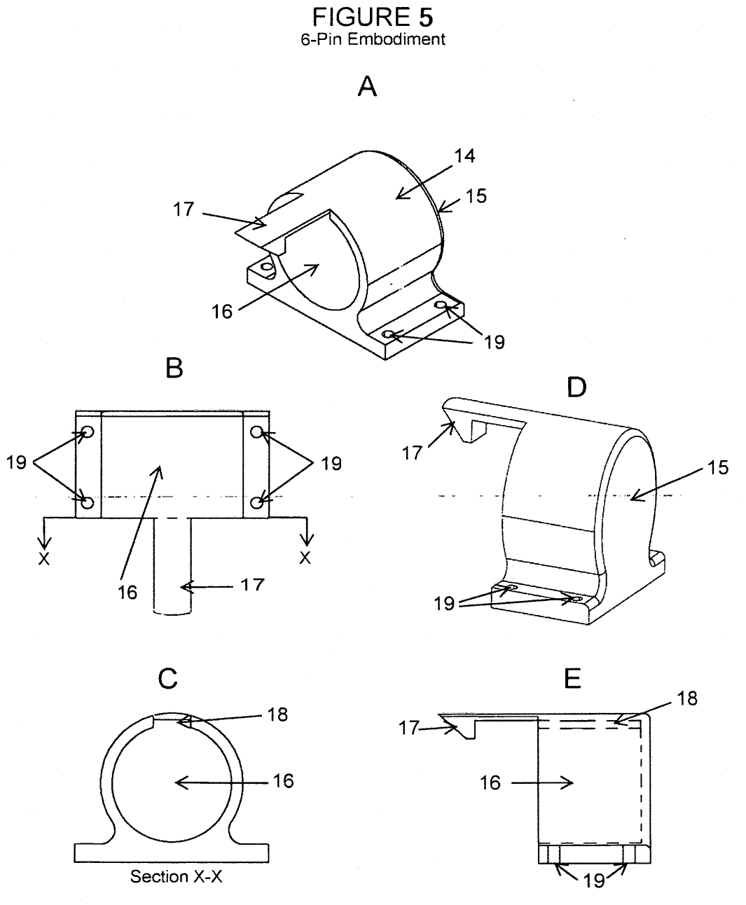

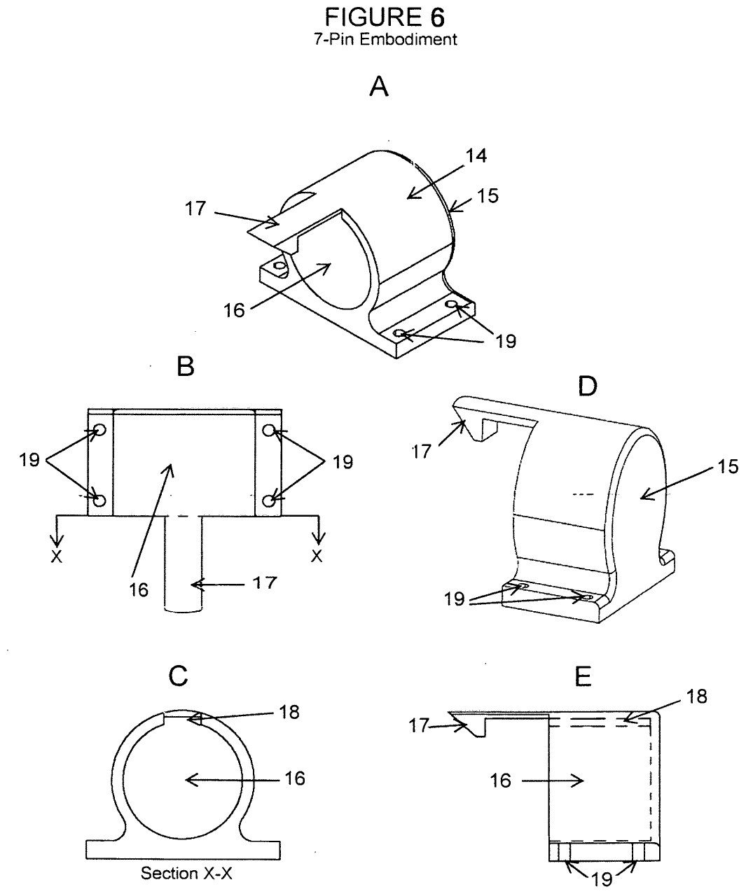

In FIG. 1, view A illustrates a conventional trailer draft bar with trailer vehicle coupling arrangement mock-up (1); showing cooperating mating terminal end connectors of an electrical trailer wire harness (2) with the present invention (3). A 4-pin embodiment is shown in this depiction. The present invention (3), a nonconductive base is secured to the draft bar of the trailer at a suitable location by the end user as illustrated in view A and the electrical trailer wire harness (2) is inserted fully into the present invention (3) to protect the electrical trailer wire harness and secure the electrical trailer wire harness to the trailer structure as illustrated in view B (4).

FIG. 2—Two-Pin Version

In FIG. 2, view A illustrates an under plan view of the 2-pin embodiment of the storage, protection and securing device. FIG. 2, view B is a sectional side view of the storage, protection and securing device constructed according to the present invention, taken along the front mating section line x-x of view A. View A and B illustrates the single female electrically nonconductive socket (5) and view A, B, and C; the one male electrically nonconductive pin (6) designed to mate with the complementary, trailer mounted, 2-pin electrical trailer wire harness plug. An integral device mounting hole (7) penetrates the device's elevated center also evident in view B and side plan view C.

FIG. 3—Four-Pin Version

FIG. 3, view A illustrates an under plan view of the 4-pin embodiment of the storage, protection and securing device. FIG. 3, view B is a sectional side view of the storage, protection and securing device constructed according to the present invention, taken along the front mating section line x-x of view A. View B and D illustrates the three female electrically nonconductive sockets (8) and one male electrically nonconductive pin (9) designed to mate with the complementary, trailer mounted, 4-pin electrical trailer wire harness plug. An integral device mounting hole (10) penetrates the device's elevated center also evident in side plan view C and in view D.

FIG. 4—Five-Pin Version

FIG. 4, view A illustrates an under plan view of the 5-pin embodiment of the storage, protection and securing device. FIG. 4, view B is a sectional side view of the storage, protection and securing device constructed according to the present invention, taken along the front mating section line x-x of view A. View A, B, D and E illustrates the four female electrically nonconductive sockets (11) and one male electrically nonconductive pin (12) designed to mate with the complementary, trailer mounted, 5-pin electrical trailer wire harness plug. An integral device mounting hole (13) penetrates the device's elevated center evident in view A, B, C, D, and E.

FIG. 5—Six-Pin Version

FIG. 5, view A illustrates a general 3D view of the 6-pin embodiment of the storage, protection and securing device; a nonconductive base (14) with one imperforate end face (15) and an axially opposite cylindrical perforate end face (16) including one female socket designed to mate with the complementary, trailer mounted, cylindrical 6-pin electrical trailer wire harness plug. View A, B, D, and E also illustrate a flexible securing mechanism (17) and view C and E illustrate an internal key way (18) that aligns and holds a complementary and integral part of the 6-pin electrical trailer wire harness plug to maintain it in a secured position when inserted into the present invention. View A, B, D, and E illustrate the presence of four integral device mounting holes (19) which perforates the nonconductive base of the present invention's lower mounting and support structure. These holes are used by the end user to mount the present invention to the trailer structure.

FIG. 6—Seven-Pin Version

FIG. 6, view A illustrates a general 3D view of the 7-pin embodiment of the storage, protection and securing device; a nonconductive base (14) with one imperforate end face (15) and an axially opposite cylindrical perforate end face (16) including one female socket designed to mate with the complementary, trailer mounted, cylindrical 7-pin electrical trailer wire harness plug. View A, B, D, and E also illustrate a flexible securing mechanism (17) and view C and E illustrate an internal key way (18) that aligns and holds a complementary and integral part of the 7-pin electrical trailer wire harness plug to maintain it in a secured position when inserted into the present invention. View A, B, D, and E illustrate the presence of four integral device mounting holes (19) which perforates the nonconductive base of the present invention's lower mounting and support structure. These holes are used by the end user to mount the present invention to the trailer structure.

### DETAILED DESCRIPTION OF THE INVENTION

Storage, protection and securing devices constructed according to the present invention, general embodiments designated in FIGS. 2-6, are particularly adapted for use with an embodiment of a trailer light or trailer light and braking electrical wiring harness, generally designated (2) in FIG. 1.

The trailer light wiring harness, generally designated (2) in FIG. 1, includes a power supply trailer light harness, generally designated, having a flat two-way, flat four-way, flat five-way, round six-way, or round seven-way terminal end connector.

The embodiments of the invention in which an exclusive property or privilege is claimed are defined as follows: The invention relates to a series of individual devices for stowing, protecting, and securing one of multiple embodiments (2-pin, 4-pin, 5-pin, 6-pin, and 7-pin) of trailer light or combined trailer light and braking system wiring harness systems. The invention reduces instances of damage from impact or dragging through the securing of the terminal end connectors of a trailer light or combined trailer light and braking system wiring harness away from the underside of the trailer vehicle coupling tongue. The invention prevents contamination of the trailer light or combined trailer light and braking system wiring harness systems from fouling, dirt, mud, moisture, or any other external elements; while reducing wire harness electrical connector exposure to corrosion causing environments.

It is conventional to provide electrical power to the lights or combined lights and braking systems of a trailer via a conductive wire harness on the draft vehicle and on the trailer which have mating terminal end connectors that are detachably coupled together. These connectors each have one or more electrically conductive male terminals and one or more electrically conductive socket/female terminals, which receive the complementally formed, female and male electrically conductive terminals on the other connector. When the draft vehicle is not coupled to the trailer, and the wiring harnesses are not coupled together, the trailer harnesses are typically left hanging from the trailer coupling tongue. On occasion, water, dirt, snow, dust, or gravel can foul or damage the conductive socket or terminal elements rendering the trailer wire harness unusable until it is repaired, cleaned, or replaced entirely. Additionally an uncoupled trailer wire harness is subject to dragging, crushing, or impact damage, and can result in unserviceability of the trailer wire harness or trailer unit.

Accordingly, it is the object of the present invention (a series of embodiments of storage, protection, and securing connectors for multiple trailer types and uses) to provide a new and novel device for preventing trailer wire harness damage from impact or dragging by providing a method to securely mount the a trailer light or combined trailer light and braking system wiring harness out of the path of the dragging and impact areas of the trailer coupling tongue, and further to securely mount and seal the connector to prevent fouling from dirt, moisture, snow, dust or any external fouling agent when the trailer is not employed by the user.

Accordingly it is another object of the present invention to provide a one piece electrically non-conductive—plug receiving—base for securing and protecting a terminal connector for a trailer wire harness when not in use. It is still another object of the present invention to provide a secure storage mechanism of the type described with no moving parts.

Accordingly, it is another object of the present invention to provide a trailer light wire harness securing and protection device which will concurrently, adequately protect and detachably seal both male and female electrical terminals in electrical connectors.

### 2-Pin Version—FIG. 2

A small number of trailer wiring harnesses include a motor vehicle mounted, two-way, flat harness connector having one male pin and one female socket and a complementally formed, trailer-mounted flat harness connector including a female socket receptacle and one male pin. There is no known one piece, insulated securing and protection device which can be easily mounted on a trailer structure and attached to, and detached from, the trailer wire harness connectors.

Accordingly it is an object of the present invention embodiment to provide a new and novel one piece protection and securing device for protecting and securing the terminal end connector of a two-way electrical wiring harness of a trailer.

It is another object of the present inventions embodiment to provide a protection and securing device of the type described including an electrically nonconductive base having an imperforate end face and an axially opposite perforate end face including at least one female socket.

It is another object of the present invention embodiment to provide a protection and securing device of the type described including one laterally adjacent nonconductive socket in an end face of an electrically nonconductive base member and an electrically nonconductive male plug integral with the base and disposed adjacent the nonconductive socket.

It is another object of the present invention embodiment to provide a protection and securing device of the type described including one central perforation in the electrically nonconductive base member to allow the base member to be affixed to the trailer structure.

Other objects and advantages of the present invention embodiment will become apparent to those of ordinary skill in the art as the description thereof proceeds.

### 4-Pin Version—FIG. 3

A large number of trailer wiring harnesses include a motor vehicle mounted, four-way, flat harness connector having one male pin and three female sockets and a complementally formed, trailer-mounted flat harness connector including a female socket receptacle and three male pins. There is no known one piece, insulated securing and protection device which can be easily mounted on a trailer structure and attached to, and detached from, the trailer wire harness connectors.

Accordingly it is an object of the present invention embodiment to provide a new and novel one piece protection and securing device for protecting and securing the terminal end connector of a 4 way electrical wiring harness of a trailer.

It is another object of the present invention embodiment to provide a protection and securing device of the type described including an electrically nonconductive base having an imperforate end face and an axially opposite perforate end face including at least one female socket.

It is another object of the present invention embodiment to provide a protection and securing device of the type described including three laterally adjacent nonconductive sockets in an end face of an electrically nonconductive base member and an electrically nonconductive male plug integral with the base and disposed adjacent the nonconductive sockets.

It is another object of the present invention embodiment to provide a protection and securing device of the type described including one central perforation in the electrically nonconductive base member to allow the base member to be affixed to the trailer structure.

Other objects and advantages of the present invention embodiment will become apparent to those of ordinary skill in the art as the description thereof proceeds.

### 5-Pin Version—FIG. 4

A large number of trailer wiring harnesses include a motor vehicle mounted, four-way, flat harness connector having one male pin and four female sockets and a complementally formed, trailer-mounted flat harness connector including a female socket receptacle and four male pins. There is no known one piece, insulated securing and protection device which can be easily mounted on a trailer structure and attached to, and detached from, the trailer wire harness connectors.

Accordingly it is an object of the present invention embodiment to provide a new and novel one piece protection and securing device for protecting and securing the terminal end connector of a 5 way electrical wiring harness of a trailer.

It is another object of the present invention embodiment to provide a protection and securing device of the type described including an electrically nonconductive base having an imperforate end face and an axially opposite perforate end face including at least one female socket.

It is another object of the present invention embodiment to provide a protection and securing device of the type described including four laterally adjacent nonconductive sockets in an end face of an electrically nonconductive base member and an electrically nonconductive male plug integral with the base and disposed adjacent the nonconductive sockets.

It is another object of the present invention embodiment to provide a protection and securing device of the type described including one central perforation in the electrically nonconductive base member to allow the base member to be affixed to the trailer structure.

Other objects and advantages of the present invention will become apparent to those of ordinary skill in the art as the description thereof proceeds.

### 6-Pin Version—FIG. 5

A large number of trailer wiring harnesses include a motor vehicle mounted, six-way, internal cylinder harness connector receiver having six male pins; five positioned equally around the circumference, with one centrally located male pin and a complementally formed, trailer-mounted cylindrical harness connector including six female, round pin, socket receptacles; five positioned equally around the circumference with one centrally located socket receptacle. There is no known one piece, insulated securing and protection device which can be easily mounted on a trailer structure and attached to, and detached from, the trailer wire harness connectors.

Accordingly it is an object of the present invention embodiment to provide a new and novel one piece protection and securing device for protecting and securing the terminal end connector of a six-way electrical wiring harness of a trailer.

It is another object of the present invention embodiment to provide a protection and securing device of the type described including an electrically nonconductive base having an imperforate end face and an axially opposite cylindrical perforate end face including one female socket to receive the trailer-mounted cylindrical harness connector including six female, round pin, socket receptacles; five positioned equally around the circumference with one centrally located socket receptacle.

It is another object of the present invention embodiment to provide a protection and securing device of the type described including one keyed alignment groove in the cylindrical perforate of the nonconductive base to align the trailer-mounted cylindrical harness connector including six female, round pin, socket receptacles; five positioned equally around the circumference with one centrally located socket receptacle to the nonconductive base member.

It is another object of the present invention embodiment to provide a protection and securing device of the type described including one securing tab emergent above the cylindrical perforate of the nonconductive base to secure the trailer-mounted cylindrical harness connector including six female, round pin, socket receptacles; five positioned equally around the circumference with one centrally located socket receptacle to the nonconductive base member.

It is another object of the present invention embodiment to provide a protection and securing device of the type described including four base located perforations in the electrically nonconductive base member to allow the base member to be affixed to the trailer structure.

Other objects and advantages of the present invention embodiment will become apparent to those of ordinary skill in the art as the description thereof proceeds.

### 7-Pin Version—FIG. 6

A large number of trailer wiring harnesses include a motor vehicle mounted, seven-way, internal cylinder harness connector receiver having six male blade style pins positioned equally around the circumference with one centrally located female socket and a complementally formed, trailer-mounted cylindrical harness connector including six female blade socket receptacles and one centrally located male pin. There is no known one piece, insulated securing and protection device which can be easily mounted on a trailer structure and attached to, and detached from, the trailer wire harness connectors.

Accordingly it is an object of the present invention embodiment to provide a new and novel one piece protection and securing device for protecting and securing the terminal end connector of a seven-way electrical wiring harness of a trailer as.

It is another object of the present invention embodiment to provide a protection and securing device of the type described including an electrically nonconductive base having an imperforate end face and an axially opposite cylindrical perforate end face including one female socket to receive the trailer-mounted cylindrical harness connector including six female blade socket receptacles and one centrally located male pin.

It is another object of the present invention embodiment to provide a protection and securing device of the type described including one keyed alignment groove in the cylindrical perforate of the nonconductive base to align the trailer-mounted cylindrical harness connector including six female blade socket receptacles and one centrally located male pin to the nonconductive base member.

It is another object of the present invention embodiment to provide a protection and securing device of the type described including one securing tab emergent above the cylindrical perforate of the nonconductive base to secure the trailer-mounted cylindrical harness connector including six female blade socket receptacles and one centrally located male pin to the nonconductive base member.

It is another object of the present invention embodiment to provide a protection and securing device of the type described including four base located perforations in the electrically nonconductive base member to allow the base member to be affixed to the trailer structure.

Other objects and advantages of the present invention embodiment will become apparent to those of ordinary skill in the art as the description thereof proceeds.

What is claimed is:

1. In combination with a 2-pin, 4-pin, or 5-pin trailer light wiring harness having a flat terminal end coupling member provided with
a plurality of laterally spaced apart, electrically conductive, elongated male pin connectors, and
a laterally spaced, electrically conductive, elongated socket member;
a trailer lighting and braking system wire harness storage, protection, and securing device for securing the trailer wire harness on the trailer structure when the trailer is not in use; protecting the terminal end connectors from damage, corrosion, and fouling; provided with a terminal end coupling member comprising:
an electrically non-conductive base having an imperforate end face and an axially opposite perforate end face including at least one female socket;
first socket means, formed in said end face complemental to said male pin connectors, disposed in said base for slidably, detachably, snugly receiving said elongated male pin connectors; and
electrically non-conductive male plug means, laterally adjacent but electrically insulated from said first socket means, integral with said base, and formed complemental to one of said elongate socket members, for being detachably, snugly received in said one elongate socket member;
said male plug means having a base end integrally coupled to said base inwardly of said end face and an opposite terminal end disposed inwardly of said end face;
means for mounting said electrically non-conductive base on a trailer vehicle adjacent the terminal end coupling member;
said means for mounting said electrically non-conductive base on a trailer vehicle via an aperture in said base for receiving fastener means for coupling to the trailer vehicle.

2. The combination set forth in claim 1 wherein said male plug means is disposed in said second socket means.

3. The combination set forth in claim 1 wherein said male plug means comprises a plurality of laterally spaced apart male plugs each having an axis lying in a predetermined plane and received in said second socket means.

4. In combination with a 6-pin or 7-pin trailer light wiring harness having a single, round, elongated male terminal end coupling member provided with
a plurality of radially spaced apart, electrically conductive, socket members, and
a centrally located, electrically conductive, elongated male pin connector;
a trailer lighting and braking system wire harness storage, protection, and securing device for securing the trailer wire harness on the trailer structure when the trailer is not in use; protecting the terminal end connectors from damage, corrosion, and fouling; provided with a terminal end coupling member comprising:
an electrically non-conductive base having an imperforate end face and an axially opposite cylindrical perforate end face including one female cavity to receive the trailer-mounted cylindrical harness connector including five or six female blade socket receptacles and one centrally located male pin;
a keyway alignment groove in the cylindrical perforate of the nonconductive base to receive the trailer-mounted 6-pin or 7-pin trailer light wiring harness having a single, round, elongated terminal end coupling member connector alignment key;
a securing tab emergent above said keyway alignment groove in the cylindrical perforate of the non-conductive base to secure the trailer-mounted 6-pin or 7-pin trailer light wiring harness having a single, round, elongated terminal end coupling member to the non-conductive base member; and
single cavity means, formed in said end face complemental to said single, round, elongated terminal end coupling member, disposed in said base for slidably, detachably, snugly receiving said 6-pin or 7-pin trailer light wiring harness terminal end connector.
means for mounting said electrically non-conductive base on a trailer vehicle adjacent the terminal end coupling member;
said means for mounting said electrically non-conductive base on a trailer vehicle via a plurality of apertures in said base for receiving fastener means for coupling to the trailer vehicle.
